(19) United States
(12) Patent Application Publication
(10) Pub. No.: US 2007/0091065 A1
(43) Pub. Date: Apr. 26, 2007

(54) Self-aligning pointing device having ESD protection

(76) Inventor: Brian James Misek, Fort Collins, CO (US)

Correspondence Address: AVAGO TECHNOLOGIES, LTD., P.O. BOX 1920, DENVER, CO, 80201-1920, US

(21) Appl. No.: 11/255,758

(22) Filed: Oct. 21, 2005

(51) Int. Cl. G09G 5/08

(52) U.S. Cl. 345/157

(57) ABSTRACT

A pointing device includes a pointer that is confined to move within a field of motion. A mounting structure is attached to a substrate and positions the field of motion upon the substrate. The pointing device further includes a restoring mechanism that returns the pointer to a predetermined resting position within the field of motion. A sensor determines the position of the pointer with respect to the substrate.

### BACKGROUND OF THE INVENTION

A pointing device is commonly used to control the movement of an indicator around a display screen of a host device, such as a computer, a cell phone, video game, television remote, or handheld computing device. The movement of the indicator (e.g. a cursor, arrow, icon, or other graphic object) on the display corresponds to the movement of the pointing device. Other pointing devices include trackballs, touchpads, joysticks, and graphics tablets. For the sake of simplicity, this discussion will refer to pointing devices used in conjunction with computers and computer displays.

In addition to controlling indicators on displays, pointing devices may also be used to control the motion of a computer-controlled device, such as a robot or remote-controlled machine.

### SUMMARY OF THE INVENTION

In an embodiment of the present invention, a pointing device includes a housing attached to a mounting structure, which is itself attached to a substrate. A pointer moves within a field of motion defined by the housing, and slides over the substrate in response to a lateral force. A sensor determines the position of the pointer with respect to the substrate. In one embodiment, springs provide a restoring force to return the pointer to a resting position within the field of motion. An alignment pattern on the substrate indicates the attachment point for the mounting structure. In one embodiment, the alignment pattern is a conductive footprint to which the mounting structure is soldered.

Further features and advantages of the present invention, as well as the structure and operation of other embodiments of the present invention, are described in detail below with reference to the accompanying exemplary drawings.

### BRIEF DESCRIPTION OF THE DRAWINGS

FIG. 1A is a top view of a pointing device.

FIG. 1B is a cross-sectional view of a pointing device, taken through the line A-A′ in FIG. 1A.

FIG. 2A is a top view of the substrate of a pointing device.

FIG. 2B is a block diagram showing a simplified schematic of the circuit formed by the electrodes in FIG. 2A.

FIG. 3 is a flowchart for a method of making a pointing device.

FIG. 4 shows a cross-sectional view of one embodiment of a pointing device.

### DETAILED DESCRIPTION

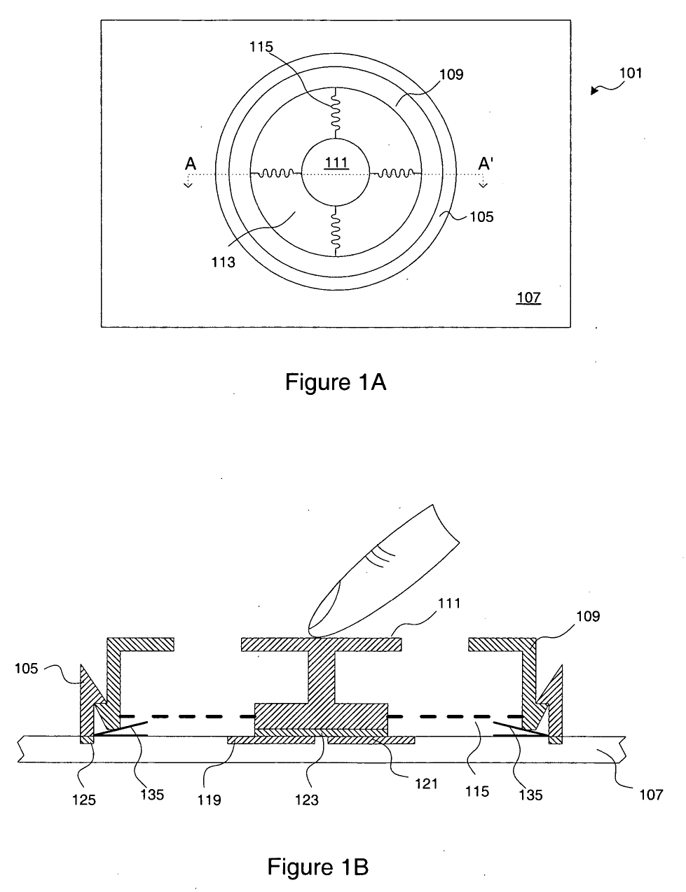

FIGS. 1A-B show a preferred embodiment of a pointing device 101 made in accordance with the teachings of the present invention. FIG. 1A shows a top view of pointing device 101. FIG. 1B shows a cross-sectional view taken along the line A-A′ in FIG. 1A. Pointing device 101 includes a housing 109 attached to a mounting structure 105, which is itself attached to a substrate 107.

The housing 109 confines the pointer 111 to move within a field of motion 113 over the substrate 107. An opening in the housing 109 gives a user access to the pointer 111, which glides over the substrate 107 in response to a lateral force. The force is typically applied to the pointer 111 by the user's finger, fingertip, thumb, thumb tip, or multiple fingers. The pointing device 101 also includes a sensor for determining the position of the pointer 111 relative to the substrate 107. The pointer 111 may be built from multiple components, including an electrode 123, the purpose of which will be described in further detail below. Many variations may be made on the pointer and housing shape and design without departing from the teachings of the present invention.

When the user applies a vertical force to the pointer 111 that is greater than a predetermined threshold, any change in the position of the pointer relative to the substrate 107 is reported to a host device. The pointing device 101 may be separate from the host device or integrated into the host device. This change in position is used to move an indicator on a display of the host device, in a manner that corresponds with the motion of the pointer 111.

When the user releases the pointer 111, springs 115 between the pointer and the housing 109 return the pointer to a predetermined resting position within the field of motion 113. The springs 115 may be attached to the pointer 111, to the housing 109, to both the pointer and the housing, or they may be completely unattached to the pointer and the housing. The springs 115 shown in the figure illustrate just one type of spring that may be used. Other acceptable spring mechanisms include meander springs, helical coiled springs, leaf springs, spiral springs, and radial springs. Further, while the figure shows the use of 4 springs for restoring the pointer 111 to a resting position, other quantities of springs may also be used.

The springs 115 provide a re-centering capability. Re-centering is typically achieved on a conventional mouse by lifting and replacing the mouse on a surface, when the surface is not large enough to provide a path over which the mouse can move and produce the desired indicator motion on the display. In pointing device 101, re-centering occurs when the user does not apply a vertical force to the pointer 111 during its return, so the change in position associated with that return motion is not reported to the host device. Re-centering is particularly useful in laptop computers, hand-held devices, and other miniature applications in which the field of motion is constrained but the display area to be covered is relatively large. For more information on details of the pointing device, please refer to U.S. patent application Ser. No. 10/723,957, by Jonah Harley, et al., filed Nov. 24, 2003 for Compact Pointing Device.

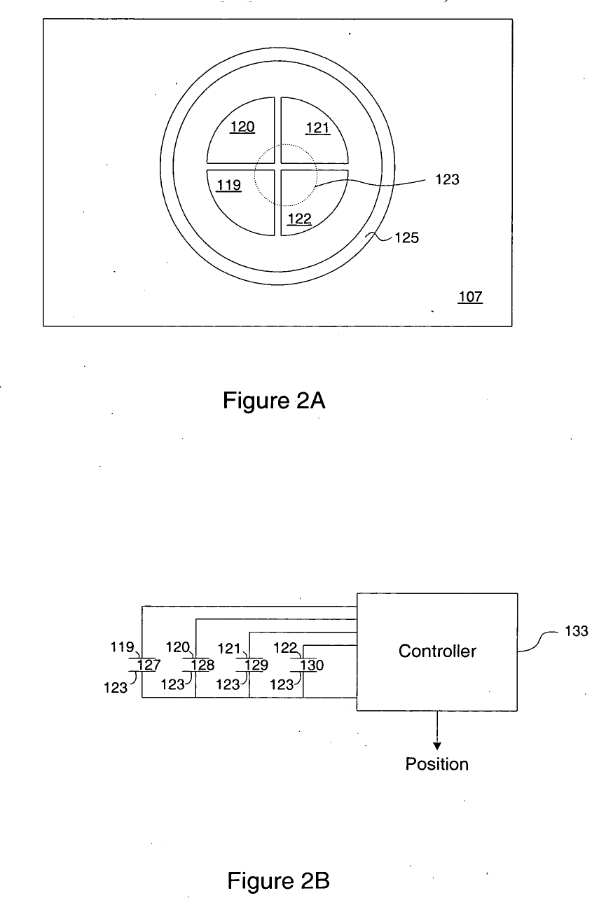

Refer now to FIG. 2A, which is a top view of the substrate 107. Electrodes 119-122 are formed on the substrate 107. Typically, the substrate 107 is a printed circuit board (PCB), but the substrate may also be a portion of a semiconductor wafer, or any other material on which electrodes 119-122 may be formed. The pointer electrode 123 is shown in outline only in FIG. 2A. The electrodes 119-123 have terminals that are connected to an external circuit. To simplify the drawing, these terminals have not been shown. Electrodes 119-123 are electrically isolated from one another. For example, the pointer electrode 123 can be covered with a dielectric layer (not shown) that provides the required insulation while still allowing the electrode to glide over the other electrodes 119-122. The number of electrodes used, their shape, and their configuration may vary as well.

Refer now to FIG. 2B, which is a schematic drawing of an equivalent circuit for electrodes 119-123. The portion of electrode 123 that overlaps electrode 119 forms a parallel plate capacitor 127 that has a capacitance proportional to the area of overlap. The portion of electrode 123 that overlaps electrode 120 forms a parallel plate capacitor 128 that has a capacitance proportional to the area of overlap. Similarly, parallel plate capacitors 129 and 130 are formed by the overlap between electrode 123 and electrodes 121 and 122, respectively. Since all the capacitors share portions of electrode 123, the equivalent circuit consists of four capacitors in parallel, connected to the common electrode 123. Therefore, by measuring the capacitance between electrode 123 and each of electrodes 119-122, the position of electrode 123 relative to the other electrodes 119-122 can be determined. This determination can be made by a controller 133, which may be part of the pointing device 101 or part of the host device of which the pointing device forms part.

This is just one of many ways that the position of the pointer 111 may be detected. For example, an optical sensor may be built into the pointer 111 for capturing images of the substrate 107 and comparing the images to determine the motion of the pointer. Optical sensors are well known in the art, and therefore will not be discussed in detail here. Many other position detectors exist that may be used to determine the position of the pointer 111 without departing from the teachings of the present invention.

The accuracy of the pointing device 101 is affected by the alignment between the electrode 123 on the pointer 111 and the electrodes 119-122 on the substrate 107. Generally, the electrode 123 should be centered over the electrodes 119-122 in its resting position for the best performance. Furthermore, some of the components in the pointing device 101 may be made of heat-sensitive materials, especially the pointer 111. However, typical manufacturing processes often include high temperature methods such as soldering and solder reflow. It would be advantageous to provide a pointing device 101 that may be assembled without damage to these heat-sensitive parts.

Another issue faced by the pointing device 101 is electrostatic discharge (ESD). ESD is a discharge of built up static electricity—it is a common occurrence that can damage unprotected electronic circuits and devices. This is especially true of the present invention, since a user must make contact with the pointer 111 to control the pointing device. Therefore, the electrodes 119-122 on the substrate and the circuitry they are connected to need to be protected from ESD shock.

To facilitate the proper positioning of the electrode 123, the substrate 107 has an alignment pattern 125 formed on its surface at a fixed distance from the substrate electrodes 119-122. The alignment pattern 125 outlines the preferred location where the mounting structure 105 should be attached. In turn, the mounting structure 105 determines where the housing 109 is attached, and therefore determines where the pointer field of motion 113 and the pointer resting position will be on the substrate. By aligning the structures through this chain of assembly, the pointer electrode 123 is centered above the substrate electrodes 119-122 in its resting position.

Referring back to FIG. 2A, in one embodiment, the alignment pattern 125 is a metal footprint formed when the substrate 107 is manufactured, in the same way and at the same time as other metal pads to which integrated circuit devices are soldered. The metal footprint surrounds the electrodes 119-122. In FIG. 2A, the metal footprint is shown in a circular shape, but other shapes such as elliptical, rectangular, etc. are also acceptable. Furthermore, the metal footprint does not need to be one continuous shape—it may be multiple discrete metal pads. Preferably, the metal footprint is symmetrical around the X- and Y-axes, for reasons to be detailed below.

During assembly, the mounting structure 105 is attached to the metal footprint. In one embodiment, the mounting structure 105 is annular in shape to match the metal footprint and has a lip with a beveled edge. Solder is applied to the metal footprint, and then the mounting structure 105 is placed onto the solder. When the solder is reflowed, the surface tension of the melted solder is equal in both axes due to the symmetry of the metal footprint, so the mounting structure 105 is pulled into place onto the metal footprint by the reflowed solder. A soldered attachment is the preferred embodiment due to the strength of the solder joint and the alignment capability provided by reflowed solder. However, conductive adhesive or other means of attaching the mounting structure 105 to the metal footprint may also be used, so long as the attachment between the mounting structure and the metal footprint is strong enough to withstand the lateral force applied to the pointer. The mounting structure does not need to be one continuous shape, either—it may be multiple discrete parts.

The housing 109 mates with the mounting structure 105. In one embodiment, the housing 109 also has a lip with a beveled edge, sized to fit within the mounting structure 105. When the housing 109 is lined up with the mounting structure, the two beveled edges slip together and facilitate the mating of the two parts. Although the housing is shown in a circular shape in the figures, other shapes such as elliptical, rectangular, etc. are also acceptable.

In one embodiment, the housing 109, springs 115, and pointer 111 are pre-assembled together and attached to the mounting structure 105 as one sub-assembly unit. Once the housing 109 is snapped into place, the springs 115 position the pointer 111 in its resting position over the substrate electrodes 119-122. Many different attachment mechanisms can be used on the mounting structure 105 and the housing 109 without departing from the teachings of the present invention. For example, the housing 109 may be attached to the mounting structure 105 with screws, press-fit connectors, conductive adhesive, etc.

As previously mentioned, the pointer 111 may include heat-sensitive components. The mounting structure 105 allows the pointer 111 to be attached with a simple latching mechanism after the soldering is finished. Furthermore, the mounting structure 105 improves the alignment between the substrate electrodes 119-121 and the pointer electrode 123, since the mounting structure it is centered on the alignment pattern 125 during solder reflow. The mounting structure 105 also provides greater repeatability in the manufacturing process.

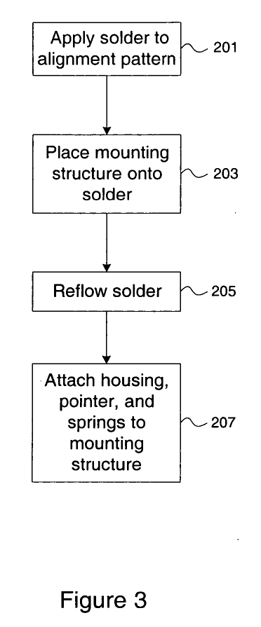

FIG. 3 is a flow chart of the assembly of the pointing device 101 as described in the above embodiment. First, in step 201, solder is applied to the alignment pattern. Typically, solder paste is screened onto the pattern, although other forms of solder or conductive adhesive may also be used. Next, in step 203, the mounting structure is placed onto the solder. Placement of the mounting structure onto the solder and the alignment pattern can be done by hand, or by a mechanical pick-and-place machine. Next, in step 205, the solder is reflowed. The alignment pattern is symmetric about the X- and Y-axes, so the surface tension of the reflowed solder is also equal in both axes. Therefore, the mounting structure is centered onto the alignment pattern when the solder is reflowed. Finally, in step 207, the housing, pointer, and springs are attached to the mounting structure after the reflow is finished. This assembly process ensures that only the mounting structure undergoes reflow.

In one embodiment, the alignment pattern is simply a fiducial mark on the substrate that indicates the attachment point for the mounting structure 105. The housing 109 is attached to the alignment pattern directly with adhesive. No solder or mounting structure 105 is needed.

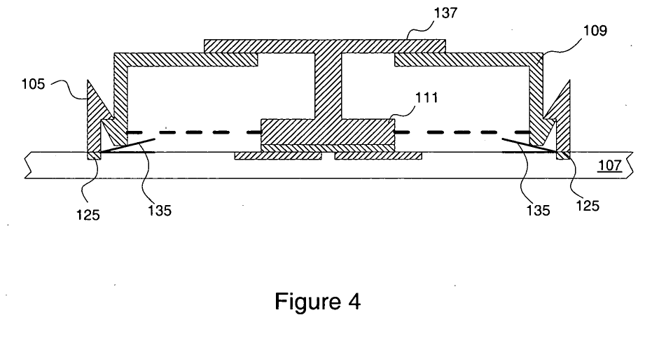

Referring now to FIG. 4, in one embodiment, the housing 109, the mounting structure 105, and the alignment pattern 125 are made of conductive material. The mounting structure 105 is connected to the alignment pattern 125 with either solder or conductive adhesive. The alignment pattern 125 is connected to a low impedance point, such as ground. Springs such as leaf springs 135 may be used to hold the housing against the mounting structure and maintain contact between these two components. The leaf springs 135 shown in the figure are only one of many ways of holding the housing against the mounting structure. The opening to the housing 109 is covered to protect the internal components such as the springs and electrodes. In the figure, the opening is covered by an upper flange 137 on the pointer 111 that extends over the top of the housing 109. The portions of the pointer 111 that are exposed to a user's touch are made of non-conductive material. When the user generates an ESD shock by touching the pointer 111, the housing 109 and the mounting structure 105 provide a conductive pathway to ground and safely shunt a high voltage shock away from the electrodes, thus protecting the electrodes and associated circuitry.

An ESD shock may be dissipated in other ways, as well. In one embodiment, the mounting structure 105, housing 109, and alignment pattern 125 are still made of conductive material, but the mounting structure is connected to the alignment pattern with non-conducting adhesive. The mounting structure 105 and the alignment pattern 125 become two plates of a large shunt capacitor to ground that protects the pointing device 101 by capacitively dividing the ESD voltage.

Although the present invention has been described in detail with reference to particular embodiments, persons possessing ordinary skill in the art to which this invention pertains will appreciate that various modifications and enhancements may be made without departing from the spirit and scope of the claims that follow.

I claim:

1. A pointing device, comprising:
a substrate;
a mounting structure attached to the substrate;
a pointer confined to move within a field of motion, wherein the mounting structure positions the field of motion on the substrate;
a restoring mechanism that returns the pointer to a resting position within the field of motion; and
a sensor that determines the position of the pointer with respect to the substrate.

2. A pointing device as in claim 1, further comprising:
a housing attached to the mounting structure, wherein the housing defines the boundaries of the pointer field of motion.

3. A pointing device as in claim 2, further comprising:
an alignment pattern formed on the substrate, wherein the mounting structure is attached to the alignment pattern.

4. A pointing device as in claim 3, wherein the alignment pattern is symmetric about the X-axis and Y-axis.

5. A pointing device as in claim 4, further comprising:
a first electrode on the pointer; and
a second electrode on the substrate, wherein the sensor detects a change in capacitance between the first and second electrodes.

6. A pointing device as in claim 3, wherein the alignment pattern comprises a conductive footprint on the substrate.

7. A pointing device as in claim 6, wherein the housing includes conductive material.

8. A pointing device as in claim 7, wherein the conductive footprint is connected to a low impedance.

9. A pointing device as in claim 8, wherein the mounting structure is soldered to the alignment pattern.

10. A pointing device as in claim 9, wherein the mounting structure and the housing form a shunt for electrostatic discharge.

11. A pointing device as in claim 8, wherein the mounting structure is connected to the alignment pattern with non-conducting adhesive.

12. A pointing device as in claim 8, further comprising springs that maintain contact between the housing and the mounting structure.

13. A pointing device as in claim 3, wherein the alignment pattern is a fiducial mark on the substrate that indicates the attachment point for the mounting structure.

14. A method for assembling a pointing device, comprising:
providing a substrate with an alignment pattern;
attaching a mounting structure to the alignment pattern;
attaching a pointer sub-assembly to the mounting structure, wherein the pointer sub-assembly includes a pointer confined to move within a field of motion over the substrate; and
determining the position of the pointer with respect to the substrate.

15. A method as in claim 14, wherein detecting a value further comprises:
providing a first electrode on the pointer;
providing a second electrode on the substrate; and
detecting a change in capacitance between the first and second electrode.

16. A method as in claim 15, wherein attaching a mounting structure to the alignment pattern further comprises:
applying solder to the alignment pattern;
placing the mounting structure onto the solder; and
reflowing the solder.

17. A method as in claim 16, wherein attaching a pointer sub-assembly further comprises:
attaching a housing to the mounting structure, wherein the housing defines the pointer field of motion.

18. A method as in claim 17, further comprising
connecting the alignment pattern to a low impedance.

19. A method as in claim 18, further comprising
shunting an electrostatic discharge through the housing and the mounting structure.
